(19) United States
(12) Patent Application Publication
(10) Pub. No.: US 2005/0129958 A1
(43) Pub. Date: Jun. 16, 2005

(54) Retaining or fixing element with an adhesive surface for sticking to a support surface

(76) Inventor: Mathias Hansel, Rummingen (DE)

Correspondence Address: Lionel D Anderson;Gifford Krass Groh Sprinkle Anderson & Citkowski, 280 N Old Woodward Avenue, Suite 400, Birmingham, MI, 48009, US

(21) Appl. No.: 10/497,440

(22) PCT Filed: Nov. 6, 2002
(86) PCT No.: PCT/EP02/12354

(30) Foreign Application Priority Data
Nov. 30, 2001 (DE) 201 19 422.8

(51) Int. Cl. B32B 17/06

(52) U.S. Cl. 428/426

(57) ABSTRACT

The invention relates to a retaining or fixing element, provided with an adhesive surface (2), for sticking to a support surface (3), whereby the adhesive surface (2) is coated with an adhesive (4) which may be melted and reactivated. According to the invention, an escape of the excess adhesive (6) from the edge (5) of the adhesive surface (2) may be avoided, whereby the adhesive surface (2) comprises an expansion groove (7, 8) along the edge (5) thereof, which serves to take up the bead (6) of adhesive which runs laterally on melting the adhesive (4) and pressing the adhesive surface (2).

### FIELD OF THE INVENTION

The present invention relates to retaining or fixing elements attachable to support surfaces. More particularly, the present invention relates to retaining or fixing elements that include adhesive surfaces coated with adhesive material for sticking to support surfaces.

### BACKGROUND OF THE INVENTION

The invention relates to a retaining or fixing element with an adhesive surface for sticking to a support surface, wherein the adhesive surface is coated with an adhesive that can be melted and reactivated. Here, the adhesive coating is typically dimensioned so that it fills up at least the entire usable adhesive surface when the adhesive coating is melted and pressed onto the support surface. This method can guarantee that the retaining or fixing element is always fixed with a defined, constant retention force on the support surface. However, this method frequently has the result that excess adhesive escapes at the edge of the adhesive surface, which gives the adhesive joint an unattractive appearance. The task of the invention is to configure the adhesive structure so that it effectively prevents the escape of adhesive past the edge.

### SUMMARY OF THE INVENTION

The present invention provides a retaining or fixing element with an adhesive surface for sticking to a support surface. The adhesive surface is coated with an adhesive that can melt and be reactivated. The adhesive surface includes an expansion groove adjacent the peripheral edge for taking up the laterally flowing adhesive bead when the adhesive is melted and the adhesive surface is pressed onto an object.

The expansion groove is dimensioned in width and height so that this groove receives the excess adhesive when the adhesive is melted and the adhesive surface is pressed onto an object.

Here, it is advantageous according to another feature of the invention for the expansion groove to have a semicircular cross section and to be located at the smallest possible distance from the edge. To ensure that the adhesive actually covers the entire adhesive surface after the adhesive process, it is also advantageous for the expansion groove to be at least partially open toward the edge.

### BRIEF DESCRIPTION OF THE DRAWINGS

The present invention will be explained in more detail in the following description with reference to the embodiments shown in the drawing. Shown are:

FIG. 1 illustrates a cross-sectional view of the outline of a conventional fixing element with adhesive applied on the adhesive surface;

FIG. 2 illustrates a cross-sectional view of the fixing element of FIG. 1 after the adhesive surface is pressed onto an object;

FIG. 3 illustrates a cross-sectional view of the fixing element of the present invention with expansion groove and adhesive;

FIG. 4 illustrates a cross-sectional view of the fixing element of FIG. 3 after the adhesive surface is pressed onto an object;

FIG. 5 illustrates a cross-sectional view of the fixing element of FIG. 3 having an alternative embodiment of the expansion groove;

FIG. 6 illustrates a cross-sectional view of the fixing element of FIG. 5 after the adhesive surface is pressed onto an object;

FIG. 7 illustrates a cross-sectional view of an alternative embodiment of the fixing element as according to the invention;

FIG. 8 illustrates a plan view of the fixing element of FIG. 7; and

FIG. 9 illustrates an enlarged cutout of the expansion groove.

### DETAILED DESCRIPTION OF THE INVENTION

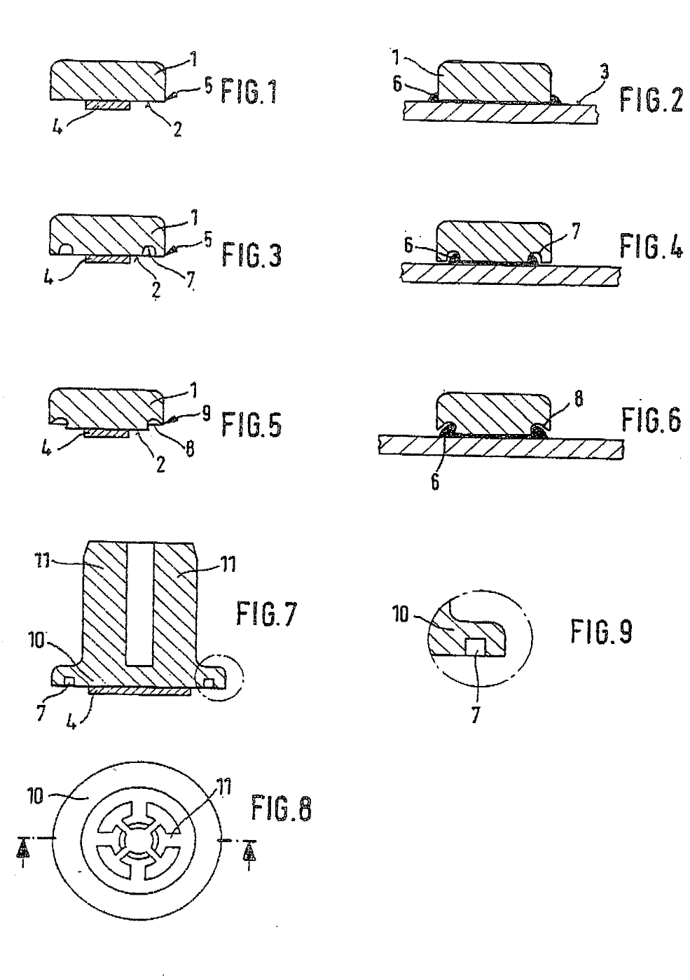

The fixing elements 1, shown purely schematically in the figures, are provided on their bottom side with an adhesive surface 2 with which the fixing element 1 is to be stuck to a support surface 3. For this purpose, as can be seen from FIGS. 1, 3, and 5, the adhesive surface 2 is provided with an adhesive 4, which is melted and applied dry to the adhesive surface 2. The adhesive 4 can be reactivated again by applying melting heat whereby the adhesive 4 can exert its full adhesive force after subsequent hardening.

FIG. 2 shows the fixing element 1 after melting of the adhesive 4 and pressing of the adhesive surface 2 onto the support surface 3. The excess adhesive escapes at the edge 5 of the adhesive surface 2 and forms a bead 6 that can be seen from the outside.

To make this bead invisible, in a first embodiment of the invention as according to FIGS. 3 and 4, the adhesive surface 2 is provided with an expansion groove 7 along the edge 5. The expansion groove has a semicircular cross section and is dimensioned so that the bead 6 flowing laterally when the adhesive 4 melts and is pressed onto the adhesive surface 2 is accommodated by this groove 7, and in this way is removed from the view of the observer. This method further guarantees that the adhesive surface 2 is always completely coated with adhesive 4 and thus has a defined retention force.

In a second embodiment of the present invention according to FIGS. 5 and 6, the expansion groove 8 is constructed to open outward toward the edge 5 at its lower edge region 9, so that one can make sure with a visual inspection that the adhesive also actually covers the entire adhesive surface 2.

FIGS. 7 and 8 illustrate a third embodiment of a fixing element having an adhesive plate 10 with an expansion groove 7 formed according to the invention and shown in FIG. 9 in an enlarged cutout. The top part of the fixing element 1 is provided with four quarter-circle clamping elements 11 that can be pressed onto a threaded bolt (not shown), for example, and fixed to it in a conventional manner.

1. A retaining or fixing element with an adhesive surface for sticking to a support surface, wherein the adhesive surface is coated with an adhesive that can melt and that can be reactivated, said element comprising: an adhesive surface (2) having an expansion groove (7, 8) along an edge (5) for taking up a laterally flowing adhesive bead (6) when adhesive (4) is melted and the adhesive surface (2) is pressed onto an object.

2. A retaining or fixing element according to claim 1, wherein the expansion groove (7) has a semicircular cross section and is located at a minimal distance from the edge (5).

3. A retaining or fixing element according to claim 1, wherein the expansion groove (8) is at least partially open toward the edge (5) at a lower edge region (9).
